(19) United States
(12) Patent Application Publication
(10) Pub. No.: US 2012/0196976 A1
(43) Pub. Date: Aug. 2, 2012

(54) USE OF ARYL DINITRILE OXIDES IN ADHESIVE COMPOSITION

(75) Inventors: José Carlos Araujo Da Silva, Pont Du Chateau (FR); Vincent Hunault, Les Martres D'artieres (FR); Pierre Robert, Clermont-Ferrand (FR); Anne Veyland, Marsat (FR)

(73) Assignees: Michelin Rechercheet Technique S.A., Granges-Paccot (CH); Societe De Technologie Michelin, Clemont-Ferrand (FR)

(21) Appl. No.: 13/258,560

(22) PCT Filed: Mar. 30, 2010
(86) PCT No.: PCT/EP10/54172

§ 371 Date: Apr. 9, 2012

(30) Foreign Application Priority Data
Mar. 31, 2009 (FR) 0952051

(51) Int. Cl. C08L 7/00; C08L 9/06; B60C 19/00; B29D 30/06; B32B 37/12; C08L 9/00; B32B 37/14

(52) U.S. Cl. 524/573; 524/575.5; 524/575; 156/307.1; 156/123; 152/367

(57) ABSTRACT

The invention relates to the use of an adhesive composition between a vulcanized rubber part and an uncured or prevulcanized or vulcanized rubber part, based on at least one highly unsaturated elastomer chosen from the group formed by natural rubber, polyisoprene, polybutadiene, styrene-butadiene, styrene-isoprene and butadiene-isoprene copolymers and styrene-butadiene-isoprene terpolymers, an aliphatic solvent and a “curing” system comprising at least one stable aryl dinitrile oxide compound.

The invention relates to the use of an adhesive composition between a vulcanized rubber part and an uncured or prevulcanized or vulcanized rubber part intended to act as tie rubber for two uncured or prevulcanized or vulcanized rubber parts for retreading worn tyres or manufacturing patches intended for repairing tyres.

Various processes are known for retreading and repairing tyres, especially tyres for heavy vehicles, aircraft or civil-engineering vehicles, “hot” retreading which consists in curing the tyre cover that has been retreaded and/or repaired using repair patches or repair rubbers, especially in the form of plugs, in a mould under pressure at a temperature of 150° C., “cold” retreading and/or repairing which consists in vulcanizing the tread and/or a protective ply and/or a carcass and a repair rubber at a relatively low temperature, of the order of 95° C. to 115° C., and “low temperature” retreading and/or repairing which consists in operating at a temperature of the order of 60° C. to 20° C. using vulcanization accelerators that are supposed to function at such a low temperature.

As for the “hot” and “cold” processes, the “low temperature” retreading or repairing process requires a good adhesion of the tie rubber to the adjacent rubbery compounds. For these tie rubbers, it is therefore necessary to use vulcanization systems that are highly reactive at ambient temperature so as to guarantee rapid curing rates and high degrees of crosslinking. These two performances of the “curing” system are indispensible in order to obtain, at ambient temperature, of the order of 20° C. to 30° C., the required level of crosslinking for this type of application in a reasonable time period, that is to say at most 24 hours. Indeed, there is a real need in the tyre retreading and repair market for a process of retreading and/or repairing by means of patches that can be carried out at ambient temperature within a time period of at most 24 hours.

The repair patches for tyres, especially for radial carcass, worn heavy vehicle tyres, comprise an assembly of various layers of rubbers, optionally comprising reinforcing elements in the form of cords generally made of synthetic textiles and a thin layer of an adhesive rubber composition intended to be applied to the inner liner of the tyre cover at the location of the cover to be repaired.

The studies carried out by the inventors have made it possible to conclude that the vulcanization accelerators conventionally supposed to function at low temperature did not make it possible to obtain a satisfactory level of crosslinking for the use as a tie rubber for two uncured or prevulcanized or vulcanized rubber parts intended for retreading or repairing tyres below 45° C. In order to solve the stated problem, the inventors then turned to another concept, namely inducing crosslinking via a compound having two functions that are highly reactive with natural rubber (NR) from ambient temperature onwards, and selected, among such compounds, the use of aryl dinitrile oxide compounds and more particularly from the latter mesitylene dinitrile oxide (MDNO).

Patent FR 1 583 406 discloses the creation of polyfunctional dinitrile oxides in situ in polymer matrices for enabling the crosslinking of the constituent polymers of such matrices, including, inter alia, polybutadienes, natural rubber, butadiene-styrene copolymers and butyl rubber, in a temperature range from 0° C. to 100° C. while recommending using ambient temperature, the crosslinking then requiring several days. This in situ creation is justified by the high instability of polyfunctional dinitrile oxides.

Patent application EP 0 903 338 A2 describes a method for synthesizing stable aryl dintrile oxide compounds, including MDNO, and indicates that these compounds can be used as agents for “curing” or “vulcanizing” saturated olefinic polymer latices at ambient temperature.

U.S. Pat. No. 6,252,009 B1 discloses the use of stable dinitrile oxides, including MDNO, for the vulcanization of acrylic polymers.

Thus, in the prior art there is no “curing” system capable, in diene elastomer compositions, that is to say in highly unsaturated elastomer compositions, for tie rubbers used for retreading tyres or patches used for repairing tyres, of conferring both curing at ambient temperature between 20° C. and 30° C. in a short time period of at most 24 hours and high crosslinking efficiency after curing at ambient temperature.

The subject of the invention relates to the use of an adhesive composition between a vulcanized rubber part and an uncured or prevulcanized or vulcanized rubber part, based on at least one highly unsaturated elastomer chosen from the group formed by natural rubber, polyisoprene, polybutadiene, styrene-butadiene, styrene-isoprene and butadiene-isoprene copolymers and styrene-butadiene-isoprene terpolymers, an aliphatic solvent and a “curing” system comprising at least one stable aryl dinitrile oxide compound.

As stable aryl dinitrile oxide compounds, the compounds described in patent application EP 0 903 338 A2 are particularly suitable.

According to one preferred embodiment, the stable aryl dinitrile oxide compound is mesitylene dinitrile oxide, MDNO, and bismesitylene dinitrile oxide, BMNO.

Advantageously, the content of stable aryl dinitrile oxide compound is between 1 and 20 phr, parts by weight per hundred parts of elastomer, preferably between 2 and 15 phr, and more preferably still between 5 and 10 phr.

According to one embodiment of the invention, the operating temperature is below 60° C., preferably the operating temperature is between 18° C. and 45° C.

According to one feature of the invention, the vulcanized rubber part is constituted by a portion of tyre, in particular it is constituted by the carcass, the tread, a sidewall of said tyre or the inner liner of said tyre.

According to another feature of the invention, the vulcanized rubber part is constituted by a portion of a tyre for heavy vehicles, for civil-engineering vehicles or for aircraft.

According to another feature of the invention, the uncured or vulcanized or prevulcanized rubber part is a constituent of a tyre repair patch.

The invention also relates to a tyre repair patch comprising at least one uncured or prevulcanized or vulcanized rubber part and an adhesive composition based on at least one highly unsaturated elastomer chosen from the group formed by natural rubber, polyisoprene, polybutadiene, styrene-butadiene, styrene-isoprene and butadiene-isoprene copolymers and styrene-butadiene-isoprene terpolymers, an aliphatic solvent and a “curing” system comprising at least one stable aryl dinitrile oxide compound.

The invention also relates to a tyre comprising at least one composition based on at least one highly unsaturated elastomer chosen from the group formed by natural rubber, polyisoprene, polybutadiene, styrene-butadiene, styrene-isoprene and butadiene-isoprene copolymers and styrene-butadiene-isoprene terpolymers, an aliphatic solvent and a “curing” system comprising at least one stable aryl dinitrile oxide compound.

### I—DETAILED DESCRIPTION OF THE INVENTION

In the present description, unless expressly indicated otherwise, all the percentages (%) shown are % by weight. Moreover, any interval of values denoted by the expression “between a and b” represents the range of values extending from greater than a to less than b (i.e., limits a and b excluded), whereas any interval of values denoted by the expression “from a to b” means the range of values extending from a up to b (i.e., including the strict limits a and b).

### I-1. Diene Elastomer

The term “diene” elastomer or rubber should be understood as meaning, in a known manner, an (one or more is understood) elastomer resulting at least in part (i.e., a homo-polymer or a copolymer) from diene monomers (monomers bearing two carbon-carbon double bonds which may or may not be conjugated).

These diene elastomers can be classified into two categories: “essentially unsaturated” or “essentially saturated”. The term “essentially unsaturated” is understood to mean in general a diene elastomer resulting at least in part from conjugated diene monomers having a content of units of diene origin (conjugated dienes) which is greater than 15% (mol %); thus it is that diene elastomers such as butyl rubbers or copolymers of dienes and of a-olefins of EPDM type do not come within the preceding definition and can in particular be described as “essentially saturated” diene elastomers (low or very low content of units of diene origin, always less than 15%). In the category of “essentially unsaturated” diene elastomers, the term “highly unsaturated” diene elastomer is understood to mean in particular a diene elastomer having a content of units of diene origin (conjugated dienes) which is greater than 50%.

The diene elastomer of the composition in accordance with the invention is preferably chosen from the group of the highly unsaturated diene elastomers consisting of polybutadienes (abbreviated to “BRs”), synthetic polyisoprenes (IRs), natural rubber (NR), butadiene copolymers, isoprene copolymers and blends of these elastomers. Such copolymers are more preferably chosen from the group consisting of butadiene-styrene copolymers (SBRs), isoprene-butadiene copolymers (BIRs), isoprene-styrene copolymers (SIRs) and isoprene-butadiene-styrene copolymers (SBIRs).

The composition may also comprise additives customarily used in rubber compositions for tyre covers, such as zinc oxide, stearic acid, zinc stearate and one or more resin(s).

### I-2 Stable Aryl Dinitrile Oxide Compound

As the stable aryl dinitrile oxide compound, mesitylene dinitrile oxide, MDNO, and bismesitylene dinitrile oxide, BMNO, are particularly suitable.

Their synthesis is described, in particular, in patent application EP 0 903 338 A2 and in the following publications:
for MDNO:
Synthesis of stable functionally substituted nitrile oxides of the aromatic series, D. V. Tsyganov, A. P. Yakubov, L. I. Belen'kii and M. M. Krayushkin, Russ. Chem. Bull, 1991, 1078-1080,
for BMNO:
Synthesis and properties of stable aromatic bis(nitrile oxides), D. V. Tsyganov, A. P. Yakubov, L. I. Belen'kii and M. M. Krayushkin, Russ. Chem. Bull, 1991, 40, 6, 1238-1243,
and Synthesis of sterically hindered dialdehyde, A. P. Yakubov, D. V. Tsyganov, L. I. Belen'kii and M. M. Krayushkin M. M. Krayushkin et al., Russ. Chem. Bull., 1991, Vol 40, No. 7, 1509-1512.

### II—EXEMPLARY EMBODIMENTS OF THE INVENTION

The following exemplary embodiments illustrate the invention without limiting it.

### II-1 Adhesion Test

The adhesive compositions in accordance with the invention are evaluated by an adhesion test.

The adhesion test consists in measuring the uniaxial tensile pull-off force of an assembled multicomponent test specimen comprising, on the one hand, the adhesive composition with the “curing” system, the tie rubber and two vulcanized compositions. The test specimen undergoes a heat treatment according to predefined conditions so that the adhesive composition can crosslink. In fact, two assemblies are found in the test specimen, which both correspond to the assembly of a retreading or repairing rubber bonded, owing to the adhesive composition, to a surface portion of a tyre corresponding respectively to a portion of a carcass ply NC for one of the assemblies and to a portion of an internal coating rubber of the tyre for the other.

The test specimen used in the adhesion test is thus a stack of 5 components: (i) a vulcanized rubber part corresponding to a surface element of a tyre (reinforcement ply made of cured textile, carcass ply NC side), (ii) an adhesive composition in accordance with the invention, (iii) a composition constituting the retreading or repairing rubber in the form of an uncured layer of small thickness, (iv) an adhesive composition in accordance with the invention and (v) a vulcanized rubber part corresponding to a surface element of a tyre (inner liner GI side).

### a) Preparation of Material (i)

The material (i) is a compound based on NR, carbon black, extender oil and other standard additives comprising a standard vulcanization system based on sulphur and on vulcanization accelerators. The material (v) is a compound of butyl rubber (copolymer of isobutylene and of isoprene), carbon black, extender oil and other standard additives comprising a standard vulcanization system based on sulphur and on vulcanization accelerators. The composition (iii), produced in the form of a very fine layer of uncured compound, is an NR/carbon black/extender oil compound free of accelerator(s) according to the formulation below:

| | |
|---|---|
| NR | 100 |
| Carbon black N660 | 50 |
| Stearic acid | 1 |
| ZnO | 3 |
| Oil PA BV1121 | 20 |
| 6PPD | 1 |
| Soluble sulphur | 2 |

The latter compound represents a repair patch.

### b) Preparation of Adhesive Compositions (ii) and (iv)

To produce the test specimens for the adhesion test, an adhesive composition according to the invention is first prepared in the form of a rubber solution, free of sulphur and of accelerator(s), composed of a volume of solvent, a diene elastomer, in this case plasticized NR and additives, corresponding to formulation 1 below:

| | phr | g | ml |
|---|---|---|---|
| Plasticized NR | 100 | 6.88 | |
| Zn stearate | 2 | 0.138 | |
| Resin-OPFT(1) | 1 | 0.069 | |
| MDNO | 7.5 | 0.516 | |
| PTF(2) | 110.5 | 7.6 | |
| Heptane | | 68.4 | 100 |
| Total rubber solution | | 76.0 | |

(1)the RESIN-OPFT resin is an octyl-substituted phenol-formaldehyde resin; and
(2)PTF represents the total weight of the constituents respectively in phr and in grams of the formulation excluding the solvent.

### c) Preparation of the Control Composition

A control test specimen is also produced with a control composition in the form of a rubber solution of the tie rubber corresponding to formulation 2 below:

| | phr | g | ml |
|---|---|---|---|
| Plasticized NR | 100 | 6.97 | |
| Zn stearate | 2 | 0.139 | |
| Resin-OPFT(1) | 1 | 0.070 | |
| ZIPX(3) | 4 | 0.279 | |
| DPG(4) | 2 | 0.139 | |
| PTF(2) | 109 | 7.6 | |
| Heptane | | 68.4 | 100 |
| Total rubber solution | | 76.0 | |

(3)ZIPX: zinc isopropyl xanthate
(4)DPG: diphenylguanidine

In order to prepare the rubber solution, the plasticized natural rubber (NR) is weighed and introduced in small pieces into a leaktight 500 ml bottle, then 70 ml of heptane is added. The bottle is sealed, then homogenized while keeping the bottle stirred overnight. The next day, the various constituents other than the NR, if need be crushed, are weighed and introduced into a second 250 ml flask. Next, 20 ml of heptane are added, then the flask is stirred for one hour at ambient temperature (22° C.). The solution obtained is then subjected to an ultrasound bath for 5 minutes, then left at rest for 5 minutes and again subjected to an ultrasound bath for a further 5 minutes. This solution is introduced into the preceding NR solution, then the 250 ml flask is rinsed with 10 ml of heptane, which are added to the flask comprising the constituents. This flask is then stirred for 10 minutes at ambient temperature. The tie rubber thus prepared in the form of a rubber solution is applied to the test specimens used for the adhesion test according to the protocol described below, as soon as the last stirring step has been carried out.

### d) Preparation of the Test Specimens

The test specimens for carrying out the adhesion test are prepared according to the sequence of steps below:
1. Cut the test specimens into small strips (parallel to the thread marks) with a width of 10 mm (i.e. around 12 small strips). (The edge zones will be removed for good reproducibility of the measurements).

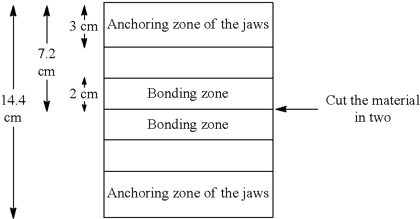

2. Cut strips of “uncured compound layer” compound of 20×10 mm in width.
3. Assemble the test specimens according to the following procedure (under a fume hood):
   Take a first small strip and apply 0.1 ml of adhesive composition
   Leave to dry for about ten minutes
   Deposit a strip of uncured compound on this area
   Carry out the same operation on the other face of the strip of uncured compound with the adhesive composition and a second small strip
4. Cure the test specimens for the desired time and at the desired temperature (24 hours at ambient temperature)

### e) Test Conditions

The test specimens thus assembled are used for carrying out the adhesion test under the following conditions:

The adhesion test is carried out at ambient temperature using an INSTRON 5565 machine. The test specimen is attached at its 2 ends over a zone of 3 cm by jaws. The upper part of the machine moves at 100 mm/min until the test specimen ruptures. The force N is represented as a function of the elongation of the test specimen tested. This force N that is also known as “pull-off force” is linked to the crosslinking efficiency: a high pull-off force signifies a high crosslinking efficiency.

The formulations 1 and 2 are used for producing 2 test specimens tested according to the protocol described above and the measurement results are recorded in the table below.

| Pull-off force (N) | ZIPX/DPG 4/2 phr | MDNO 7.5 phr |
|---|---|---|
| Average | 115.6 | 312.1 |
| Standard deviation | 10.9 | 54.2 |

The results obtained show that the pull-off force obtained with the tie rubber corresponding to formulation 1 in accordance with the invention is 2.7 times greater than that obtained with the tie rubber corresponding to the control formulation 2 containing the ZIPX/DPG accelerator system (system known for a priori functioning at relatively low temperatures such as 60° C., and here it can be said that the pull-off force is insufficient), which reveals a significant crosslinking activity of the MDNO in the set time period of 24 hours relative to a solution using conventional vulcanization accelerators. The level of crosslinking reaches the level of crosslinking required for this type of rubber application, namely as tie rubber for two uncured or prevulcanized or vulcanized rubber parts for the manufacture of retreaded tyres for heavy vehicles, in particular having a radial carcass, or the manufacture of patches intended for repairing worn tyres.

1. A method for the use of an adhesive composition between a vulcanized rubber part and an uncured or prevulcanized or vulcanized rubber part, based on at least one highly unsaturated elastomer chosen from the group formed by natural rubber, polyisoprene, polybutadiene, styrene-butadiene, styrene-isoprene and butadiene-isoprene copolymers and styrene-butadiene-isoprene terpolymers, an aliphatic solvent and a “curing” system comprising at least one stable aryl dinitrile oxide compound.

2. The method of use according to claim 1, wherein the stable aryl dinitrile oxide compound is mesitylene dinitrile oxide (MDNO).

3. The method of use according to claim 1, wherein the stable aryl dinitrile oxide compound is bismesitylene dinitrile oxide (BMNO).

4. The method of use according to claim 1, wherein the content of stable aryl dinitrile oxide compound is between 1 and 20 phr, parts by weight per hundred parts of elastomer.

5. The method of use according to claim 4, wherein the content of stable aryl dinitrile oxide compound is between 2 and 15 phr.

6. The method of use according to claim 5, wherein the content of stable aryl dinitrile oxide compound is between 5 and 10 phr.

7. The method of use according to claim 1, wherein the operating temperature is below 60° C.

8. The method of use according to claim 7, wherein the operating temperature is between 18° C. and 45° C.

9. The method of use according to claim 1, wherein the vulcanized rubber part is constituted by a portion of a tyre.

10. A method of use according to claim 9, wherein the portion of the tyre which constitutes the vulcanized rubber part is the carcass of said tyre.

11. A method of use according to claim 9, wherein the portion of the tyre which constitutes the vulcanized rubber part is the tread of said tyre.

12. A method of use according to claim 9, wherein the portion of the tyre which constitutes the vulcanized rubber part is a sidewall of said tyre.

13. A method of use according to claim 9, wherein the portion of the tyre which constitutes the vulcanized rubber part is the inner liner of said tyre.

14. A method of use according to claim 9, wherein the tyre is a heavy vehicle tyre.

15. A method of use according to claim 9, wherein the tyre is a civil-engineering vehicle tyre.

16. A method of use according to claim 9, wherein the tyre is an aircraft tyre.

17. A method of use according to claim 9, wherein the uncured or vulcanized or prevulcanized rubber part is a constituent of a tyre repair patch.

18. A tyre repair patch comprising at least one uncured or prevulcanized or vulcanized rubber part and an adhesive composition based on at least one highly unsaturated elastomer chosen from the group formed by natural rubber, polyisoprene, polybutadiene, styrene-butadiene, styrene-isoprene and butadiene-isoprene copolymers and styrene-butadiene-isoprene terpolymers, an aliphatic solvent and a “curing” system comprising at least one stable aryl dinitrile oxide compound.

19. A tyre repair patch according to claim 18, wherein the stable aryl dinitrile oxide compound is mesitylene dinitrile oxide (MDNO).

20. A tyre repair patch according to claim 18, wherein the stable aryl dinitrile oxide compound is BMNO.

21. A tyre comprising at least one composition based on at least one highly unsaturated elastomer chosen from the group formed by natural rubber, polyisoprene, polybutadiene, styrene-butadiene, styrene-isoprene and butadiene-isoprene copolymers and styrene-butadiene-isoprene terpolymers, an aliphatic solvent and a “curing” system comprising at least one stable aryl dinitrile oxide compound.

22. A tyre according to claim 21, wherein the stable aryl dinitrile oxide compound is mesitylene dinitrile oxide (MDNO).

23. A tyre according to claim 21, wherein the stable aryl dinitrile oxide compound is BMNO.
